(19) United States
(12) Patent Application Publication
(10) Pub. No.: US 2012/0272477 A1
(43) Pub. Date: Nov. 1, 2012

(54) HINGE WITH WELD GUIDE

(76) Inventor: Larry Mirick, Manhattan Beach, CA (US)

(21) Appl. No.: 13/096,954

(22) Filed: Apr. 28, 2011

(51) Int. Cl. E05D 11/02; E05D 11/00

(52) U.S. Cl. 16/274; 16/386

(57) ABSTRACT

A cylindrical barrel hinge with weld guide including a plurality of cylindrical barrel hinge portions and a weld guide extending outwardly from at least one of the generally cylindrical barrel hinge portions. The weld guides help stabilize the cylindrical barrel hinge and prevent it from rolling or shifting on parts to which the barrel hinge will be welded.

### BACKGROUND OF THE INVENTION

There are a wide variety of hinges available to hinge together two or more pieces. In the case of barrel hinges, barrel hinges find numerous application in light to heavy duty applications, such as hinging together ramps and doors to trailers and the like. Barrel hinges include at least two generally cylindrical portions that are rotatably engaged together. Adjacent generally cylindrical portions are affixed to the parts to be hinged together. Barrel hinges are attached to the pieces by welding. However, since their outer walls are generally cylindrical, during the welding process, the hinges may roll around and move relative to the pieces they are to be welded to. Thus, in order to properly align and hold barrel hinges as they are welded in place, jigs and/or clamps must generally be used. This takes extra time and effort. While there are barrel hinges that include barrel portions formed with out of round profiles, e.g., teardrop shaped profiles, these are more costly to produce, especially when forming larger sized barrel hinges.

### BRIEF DESCRIPTION OF THE INVENTION

The invention provides a barrel hinge with weld guides. The weld guides comprise one or more protrusions extending from an outer surface of portions of the barrels. The protrusions extend out far enough relative to the outer surface of the barrel portions so that when the barrel hinge is laid on or against the two pieces to be welded together, the protrusions will impinge on the pieces to be welded together to help prevent rolling of the barrel hinge, and maintain the position of the barrel hinge during which the welder can weld the barrel hinge in place.

The weld guides can comprise several different structures. For example, the weld guides can comprise two or more spaced apart and longitudinally positioned crimps on the outside wall of the barrel hinge, which two or more crimps have the same height that will rest evenly on the piece to which the barrel hinge will be welded. In lieu of two or more spaced apart and longitudinally positioned crimps, a single elongate crimp with a consistent height and shape can be used instead. Crimps are useful where the wall thickness of the barrel hinge part is sufficiently thick such that the crimps do not unduly impinge on a cavity of the barrel hinge or there is no cavity. In cases where use of crimps is not feasible, for example, a thin walled tubular barrel section, a section of rod can be longitudinally affixed, e.g., welded, to the outside of the barrel section. The section of rod will preferably extend the same height away from the outer surface of the barrel hinge if mixed in with a barrel hinge using crimps as the weld guide.

Instead of crimps or rods, the weld guides can comprise other protrusions that are permanently affixed to the outside of the barrel hinge sections, such as triangular stops, that can be spot welded thereto.

### BRIEF DESCRIPTION OF THE DRAWINGS

FIG. 1 is an exploded and partially exposed view of an embodiment of a barrel hinge with exemplary embodiment of weld guides of the invention.

FIG. 2 is a top view of the assembled barrel hinge with exemplary embodiment of weld guides of FIG. 1.

FIG. 3 is a detail showing exemplary weld guides on a portion of the barrel hinge of FIG. 2.

FIG. 4 is a detail showing another exemplary weld guide on a portion of a barrel hinge of FIG. 2.

FIG. 5 is a top plan view showing the barrel hinge with weld guides of FIG. 2 affixed to two parts to be hinged together.

FIG. 6 is a perspective view of the barrel hinge with weld guides of FIG. 5 affixed to two parts to be hinged together.

FIG. 7 is a cross-sectional view through view lines 7-7 of FIG. 6.

FIG. 8 is an exploded and partially exposed view of another embodiment of a barrel hinge with exemplary embodiment of weld guides of the invention.

FIG. 9 is a top view of the assembled barrel hinge with exemplary embodiment of weld guides of FIG. 8.

FIG. 10 is a perspective view of a barrel hinge part with other exemplary weld guides attached to an outer wall thereof.

FIG. 11 is a perspective view of yet another exemplary weld guide of the invention.

FIG. 12 is a cross-section view through view lines 12-12 of FIG. 11.

### DETAILED DESCRIPTION

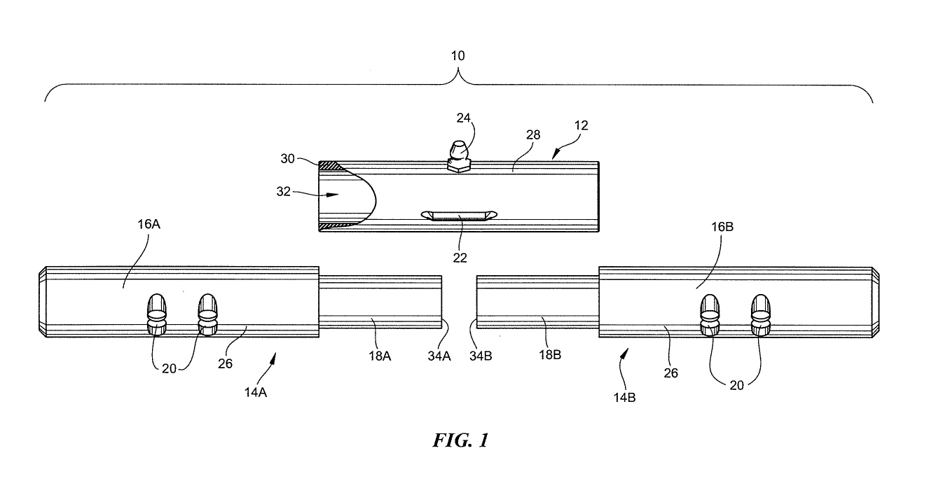

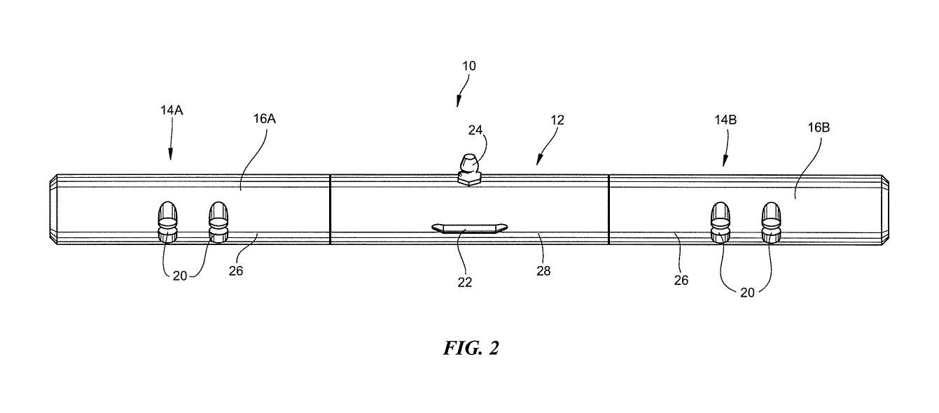

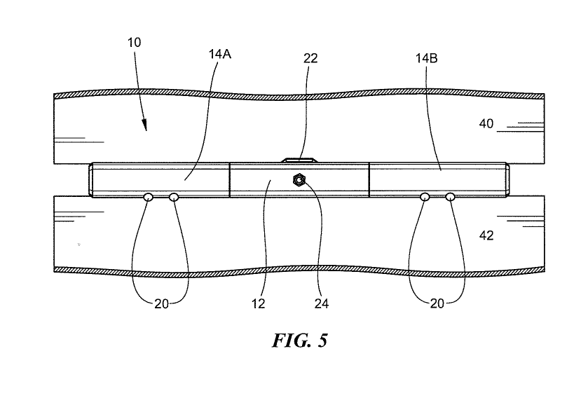

FIG. 1 is an exploded and partially exposed view of an embodiment of a barrel hinge 10 with exemplary embodiment of weld guides of the invention. The barrel hinge 10 comprises a female barrel portion 12 and two male barrel portions 14A and 14B. The male barrel portions 14A and 14B have main body portions 16A and 16b, respectively, with pin extensions 18A and 18B, respectively extends from ends thereof. The pin extensions 18A and 18B have terminal ends 34A and 34B, respectively. The female barrel portion 12 is tubular in construction with a wall 30 that defines a longitudinal bore 32 formed therethrough. The pin extensions 18A and 18B have a diameter that is sized slightly smaller than an inner diameter of the bore 32 formed in the female barrel portion 12 so that rotation of the male barrel portions 14A and 14B relative to the female barrel portion 12 is possible. Weld guides 20, in the form of crimps, are formed on the outer surface 26 of the main body portions 16A and 16b of male barrel portions 14A and 14B. Located on an outer surface 28 of the female barrel portion 12 is weld guide 22. Also optionally located on the female barrel portion 12 is a grease fitting 24 through which grease can be inserted in a space inside the bore of the female barrel portion 12 between that will be formed between the terminal ends 34A and 34B of the pin extensions 18A and 18B. The grease will work its way between the outer surface of the pin extensions 18A and 18B and inner walls 30 of the bore 32 to provide lubrication for movement of the male barrel portions 14A and 14B relative to the female barrel portion 12. The outer diameter of the female barrel portion 12 and the diameters of the main body portions 16A and 16B of male barrel portions 14A and 14B are preferably the same, as best shown in FIG. 2, which is a top view of the assembled barrel hinge with exemplary embodiment of weld guides of FIG. 1, showing the referenced features but without the bore 32 of the female barrel portion 12 being revealed. Providing the male and female barrel portions with the same outer diameter ensures that they lay flat relative to the pieces to which they will welded, as best shown in FIGS. 5-7 below.

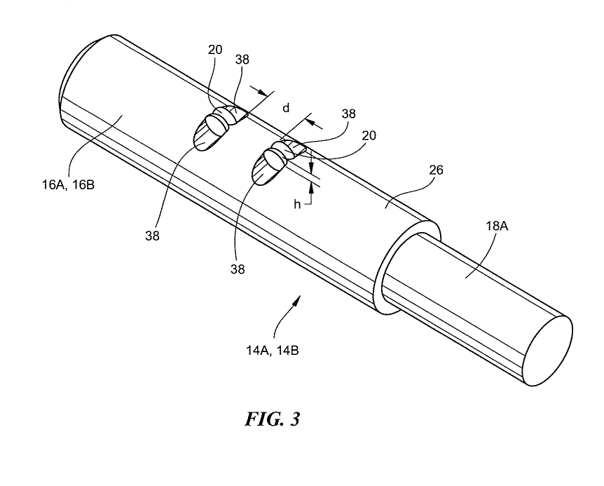

FIG. 3 is a detail showing the exemplary weld guides in the form of crimp 20 formed on the main body portions 16A and 16B of male barrel portions 14A and 14B. The crimps 20 can be formed by squeezing in material 38 from the outer surface 26 of the male barrel portions 14A and 14B to create crimps with a height “h1”. The crimps are spaced apart a distance “d” and are aligned longitudinally along the outer surface of the male barrel portions 14A and 14B.

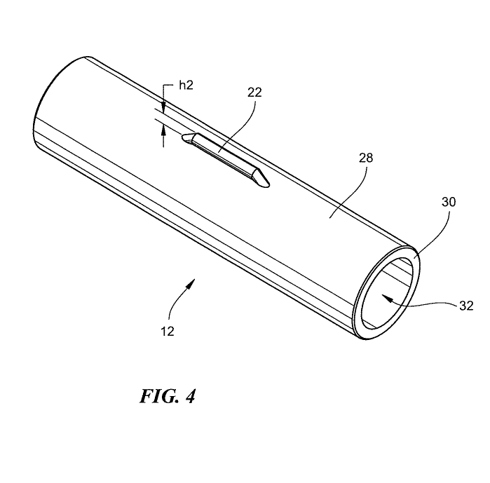

FIG. 4 is a detail showing the exemplary weld guide 22 attached to an outer surface 28 of the female barrel portion 12. In the case of the female barrel portion 12, since it is tubular in construction with walls 30 and a bore 32, if weld guides in the form of crimps were to be made on the tubular walls, if the wall 30 are thin, this might distort or impinge into the cylindrical bore 32. Therefore, instead of crimps, a weld guide 22 in the form of an elongate section of metal, such as a rectangular rod, is spot welded longitudinally to the outer surface 28 of the female barrel portion 12. The weld guide 22 extends a height “h2” off of the outer surface 28 of the female barrel portion 12. The height “h2” of weld guide 22 can preferably be the same or about the same as the height “h1” of weld guide 20 so that when female barrel hinge 20 and male barrel hinge portions 14A and 14B are welded to their respective parts to be hinged together (as will be described below with respect to FIGS. 5-7), a uniform weld bead can be used to weld the barrel hinge to the pieces to be welded together. However, if the heights h1 and h2 of the weld guides 20 and 22, respectively, differ, they would still provide a benefit as the weld guides would prevent the barrel hinge 10 from rolling around relative to the pieces to be welded together even if not held in a jig or otherwise clamped in place. If the walls 30 are thick enough, it is possible to use crimps in lieu of weld on rod as the weld guide.

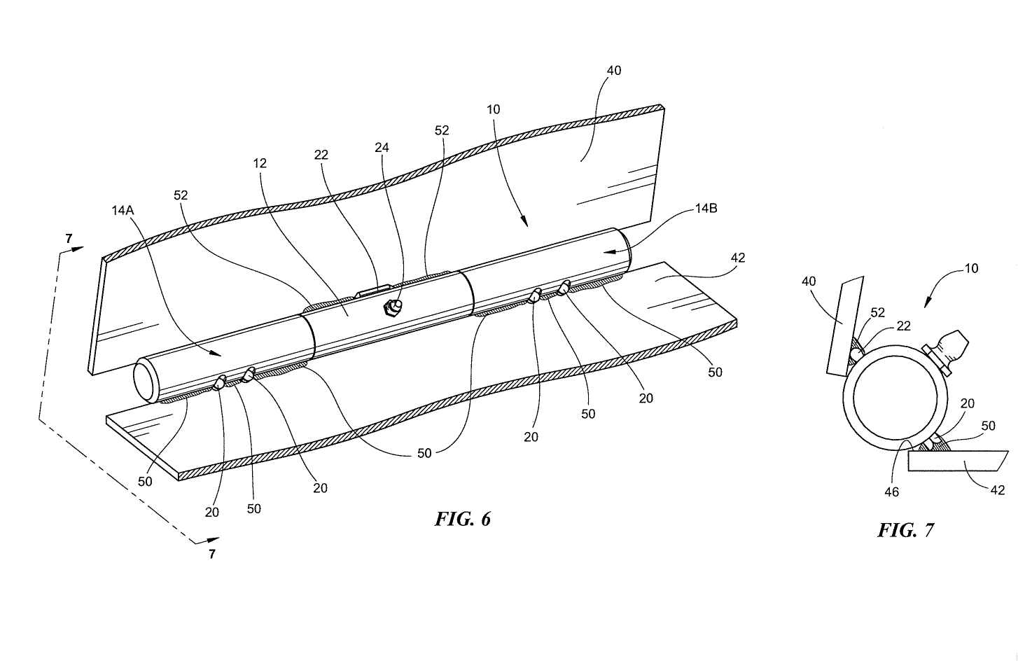

FIG. 5 is a top plan view, FIG. 6 is a perspective view, and FIG. 7 is a cross-sectional view through view lines 7-7 of FIG. 6 showing the barrel hinge 10 with exemplary weld guides of FIG. 2 welded to two parts 40 and 42 to be hinged together. As can be seen, the barrel hinge 10 will rest on its bottom edge 46 on the pieces to be hinged together 40 and 42, with the weld guides 20 contacting piece 42 and with weld guide 22 contacting piece 40. The weld guides 20 and 22 will thus prevent the barrel hinge 10 from rolling relative to the pieces to be welded together and allow a welder to locate the barrel hinge 10 where required relative to the pieces 40 and 42 to be hinged together without needing to use clamps or jigs. Thereafter, the welder can apply weld beads 50 to attach the male barrel portions 14A and 14B to piece 42, and can apply weld beads 52 to attach the female barrel portion 12 to piece 40. As noted above, when the heights of the weld guides 20 and 22 are equal, uniformly and consistently sized weld beads 50 and 52 can be applied to ensure maximum weld strength.

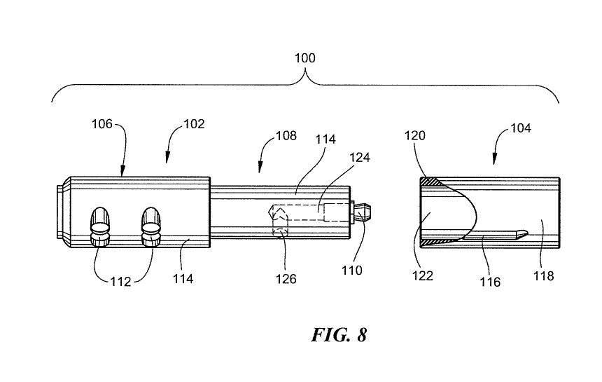

FIG. 8 is an exploded and partially exposed view of another embodiment of a barrel hinge 100 having with exemplary embodiment of weld guides 112 and 116 of the invention. The weld guides 112 and 116, are of the same form as weld guide 20 and 22, respectively, as described above with reference to FIGS. 1-7. In this barrel hinge 100, there is a single male barrel portion 102 with longitudinally located weld guides 112 formed thereon, and a female barrel portion 104 with weld guide 116 attached thereto. The male barrel portion has a main body portion 106 and a pin extension 108 with a grease fitting 110. The grease fitting 110 communicates with a longitudinal channel 124 formed partially through the pin extension 108 that opens up into orifice 126 communicating to the outside surface 114 of the pin extension 108. It is through the orifice 126 that grease will be deposited between the outside of the pin extension 108 and the inside of the wall 120 of the female barrel portion 104. The female barrel portion 104 has a weld guide 116 attached to an outer surface 118 thereof. The female barrel portion 104 has wall 120 and a bore 122 formed therein. The pin extension 108 has a diameter less than the bore 122 of the female barrel portion 104 and thus the male barrel portion 102 and female barrel portion 104 are rotatably relative to each other. Making the main body portion 106 of the male barrel portion 102 and female barrel portion 104, respectively, with the same outer diameter ensures that they lay flat relative to the pieces to which they will be welded.

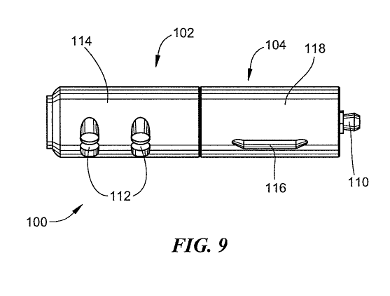

FIG. 9 is a top view of the assembled barrel hinge 100 with exemplary embodiment of weld guides 112 and 116 of FIG. 8 with pin extension (not shown) inserted through the bore (not shown) and with grease fitting 110 extending and being accessible.

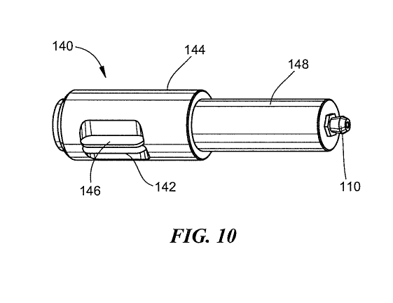

FIG. 10 is perspective view of an exemplary embodiment of a barrel hinge portion 140 with a pin extension 148 has another weld guide 142, which is in the form of an elongate and longitudinally oriented crimp formed on the outer surface 144 of the barrel hinge portion 140. The elongate crimp 142 can be formed by squeezing in material 146 from the outer surface 144 of the barrel portion 140 to create an elongate crimp with a desired height. This crimp 142 will function in the same manner as the aforementioned weld guide crimps 20 and provide stability as a welded welds the barrel hinge in place.

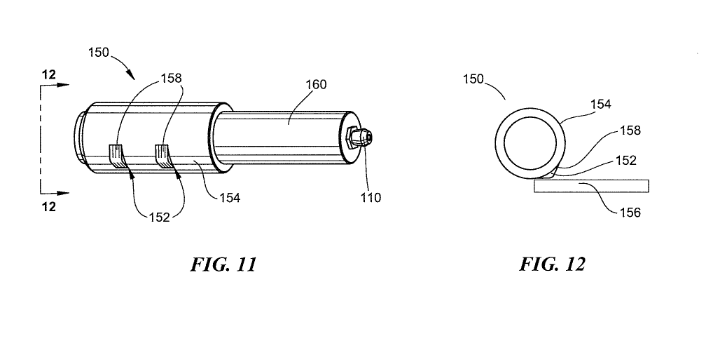

FIG. 11 is a perspective view of a barrel hinge part 150 with other exemplary weld guides 152 attached to an outer wall 154 thereof, and FIG. 12 is a cross-sections view of same through view lines 12-12 of FIG. 11, but placed on a piece 156 to which the barrel hinge part 150 will be welded. The barrel hinge part 150 is shown as a male barrel hinge part with a pin extension 160, but the weld guides 152 can also be applied to female barrel hinge parts as well. The weld guides 152 have a generally trapezoidal cross section with the wider base affixed to the outer wall 154 of the barrel hinge part 150. The height of the weld guides 152 and angle of the sloped edges 158 are such that when the weld guides 152 make contact with piece 156, the weld guides 152 will stabilize the barrel hinge portion 150 in place and prevent rolling or shifting. The weld guides 152 are aligned longitudinally on the outer surface 154 of the barrel hinge part 150. While two weld guides 152 are shown, more than two weld guides can be used or a single, elongate weld guide can be used. The weld guide can be spot welded or otherwise permanently attached to the barrel hinge part 150, which can be a male or female barrel portion.

Although the embodiments of barrel hinges shown herein include grease fittings, the weld guides are equally applicable to barrel hinges without grease fitting. Moreover, the weld guides are equally applicable to barrel hinges made up of tubular sections that are welded to parts to be hinged together, with tubular or cylindrical rod that rotatably passes through the tubular sections, wherein the tubular sections would carry the weld guides.

Having thus described the exemplary embodiments of the present invention, it should be understood by those skilled in the art that the above disclosures are exemplary only and that various other alternatives, adaptations, and modifications may be made within the scope of the present invention. The presently disclosed embodiment is to be considered in all respects as illustrative and not restrictive. The scope of the invention being indicated by the appended claims rather than the foregoing description, and all changes which come within the meaning and range of equivalency of the claims are, therefore, intended to be embraced therein.

What is claimed is:

1. A cylindrical barrel hinge with weld guide, comprising:
a plurality of generally cylindrical barrel hinge portions; and
a weld guide extending outwardly from at least one of the generally cylindrical barrel hinge portions.

2. The cylindrical barrel hinge with weld guide of claim 1, wherein weld guides are longitudinally oriented on the plurality of generally cylindrical barrel hinge portions.

3. The cylindrical barrel hinge with weld guide of claim 1, wherein the weld guide comprise a plurality of spaced apart separate crimps that are formed into and longitudinally aligned on an outer wall of at least one of the plurality of generally cylindrical barrel hinge portions.

4. The cylindrical barrel hinge with weld guide of claim 1, wherein the weld guide comprises an elongate crimp that is formed into and longitudinally aligned on an outer wall of at least one of the plurality of generally cylindrical barrel hinge portions.

5. The cylindrical barrel hinge with weld guide of claim 1, wherein the weld guide comprises an elongate section of material that is longitudinally aligned and permanently attached on at least one of the plurality of generally cylindrical barrel hinge portions.

6. The cylindrical barrel hinge with weld guide of claim 5, wherein the section of material comprises a section of rod welded to the outside of the at least one of the plurality of generally cylindrical barrel hinge portions.

7. The cylindrical barrel hinge with weld guide of claim 5, wherein the weld guide has a generally rectangular cross section.

8. The cylindrical barrel hinge with weld guide of claim 5, wherein the weld guide has a generally trapezoidal cross section.

9. The cylindrical barrel hinge with weld guide of claim 1, wherein the barrel hinge comprises a female barrel section with a cylindrical outer wall with an outer diameter and a bore having an inner diameter formed therethrough, and at least one male barrel portion having a main body portion with a main body portion outer diameter and a pin extension extending longitudinally from the main body portion, the pin extension having an outer diameter, which outer diameter is smaller than the inner diameter of the bore of the female barrel section, the male and female barrel portions being rotatable relative to each other with the pin extension is positioned in the bore, wherein a weld guide is located on the female barrel portion and on the at least one male barrel portion.

10. The cylindrical barrel hinge with weld guide of claim 9, wherein the weld guides on the female and male barrel portions have generally the same heights.

11. The cylindrical barrel hinge with weld guide of claim 9, wherein the weld guide on the at least one male barrel portion comprises one of an elongate crimp that is formed into and longitudinally aligned on an outer wall of the at least one male barrel hinge portion, and a plurality of spaced apart separate crimps that are formed into and longitudinally aligned on an outer wall of the at least one male barrel hinge portion.

12. The cylindrical barrel hinge with weld guide of claim 9, wherein the weld guide on the female barrel portion comprises an elongate section of material that is permanently attached and longitudinally aligned on the outer wall of the female barrel portion.

13. The cylindrical barrel hinge with weld guide of claim 1, further comprising a grease fitting.

14. A cylindrical barrel hinge with weld guide, comprising:
at least two barrel hinge portions which rotatably engage with each other and which have cylindrical outer surfaces; and
a weld guide extending outwardly from the cylindrical outer surfaces of the at least two barrel hinge portions.

15. The barrel hinge with weld guide of claim 14, wherein the weld guide comprise at least one of an elongate crimp and a plurality of spaced apart separate crimps that are formed into and longitudinally aligned on an outer wall of at least one of the two barrel hinge portions.

16. The barrel hinge with weld guide of claim 14, wherein the weld guide comprises an elongate section of material that is permanently attached and longitudinally aligned on an outer wall of at least one of the two barrel hinge portions.

17. The barrel hinge with weld guide of claim 14, wherein the weld guides extend generally the same height from the cylindrical outer surfaces of the at least two barrel hinge portions.
